(19) United States
(12) Patent Application Publication
(10) Pub. No.: US 2019/0311618 A1
(43) Pub. Date: Oct. 10, 2019

(54) Apparatus and Method for Identifying an Over-Speed Condition of a Vehicle

(71) Applicant: Bendix Commercial Vehicle Systems LLC, Elyria, OH (US)

(72) Inventors: Ken D. Au, Irvine, CA (US); Travis G. Ramler, Fairfield, UT (US); William P. Amato, Avon, OH (US); Andrew J. Pilkington, Avon Lake, OH (US); Nicholas A. Broyles, Elyria, OH (US); Ashish Pandit, Farmington Hills, MI (US)

(21) Appl. No.: 15/949,651

(22) Filed: Apr. 10, 2018

(51) Int. Cl. G08G 1/052; G07C 5/00; G07C 5/02; G08G 1/04

(52) U.S. Cl. CPC G08G 1/052; G08G 1/04; G07C 5/02; G07C 5/008

(57) ABSTRACT

A controller for identifying an over-speed condition of a vehicle is adapted to identify a current posted speed limit; determine whether to identify an over-speed condition of the vehicle based on the current posted speed limit, a previous posted speed limit and a current speed of the vehicle; and if it is determined to identify the over-speed condition, transmit an over-speed warning signal to activate a warning device.

### BACKGROUND

The present invention relates to an over-speed warning system. It finds particular application in conjunction with determining when to identify an over-speed condition and will be described with particular reference thereto. It will be appreciated, however, that the invention is also amenable to other applications.

Vehicle and operator (e.g., driver) monitoring and reporting services use sensors on the vehicle to collect data (e.g., safety data) from the vehicle, transform the data into actionable information and report the data to an owner (e.g., a fleet) of the vehicle. In some cases, the safety data is reported by wirelessly transmitting the safety data to the owner. Such systems typically use cameras to collect images of speed limit signs along a road on which the vehicle is travelling. The images of the speed limit are then processed by the monitoring service and a current speed limit is identified. If the vehicle monitoring service determines the vehicle is traveling above the identified speed limit, a report and/or warning may be logged.

In certain situations, an image of a speed limit sign may be captured that does not reflect the actual speed limit. For example, an image of a speed limit sign along an exit ramp may be captured if the vehicle is traveling along the main portion of a highway. In that case, although the vehicle is still traveling on the main portion of the highway, which has a higher speed limit than the exit ramp, the vehicle monitoring service identifies the current speed limit as the speed limit on the exit ramp. Since the speed limit on the exit ramp is commonly significantly lower than the speed limit on the main portion of the highway, the monitoring system may inaccurately report that the driver is operating the vehicle at a speed significantly above the speed limit.

The present invention provides a new and improved apparatus and method for identifying an over-speed condition.

### SUMMARY

In one aspect of the present invention, it is contemplated that a controller for identifying an over-speed condition of a vehicle is adapted to identify a current posted speed limit; determine whether to identify an over-speed condition of the vehicle based on the current posted speed limit, a previous posted speed limit and a current speed of the vehicle; and if it is determined to identify the over-speed condition, transmit an over-speed warning signal to activate a warning device.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a vehicle passing various speed limit signs while driving along a road in accordance with one embodiment of an apparatus illustrating principles of the present invention; and

FIG. 2 is an exemplary methodology of identifying an over-speed condition in accordance with one embodiment illustrating principles of the present invention.

### DETAILED DESCRIPTION OF ILLUSTRATED EMBODIMENT

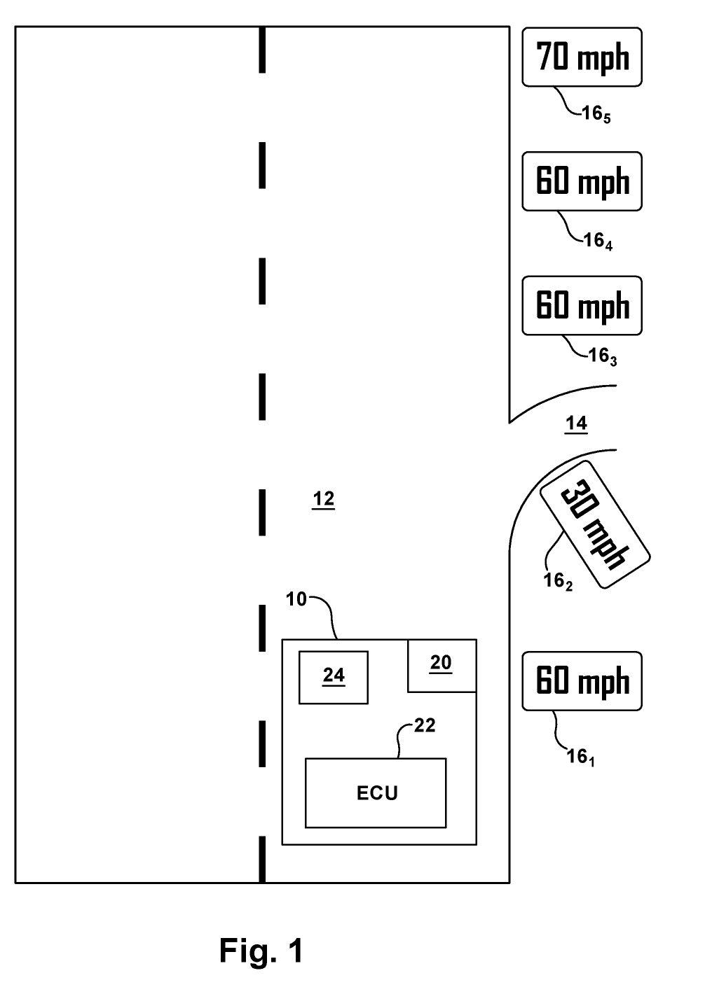

With reference to FIG. 1, a schematic representation of a vehicle 10 driven by an operator (e.g., driver) along a road 12 including an exit ramp 14 in accordance with one embodiment of an apparatus illustrating principles of the present invention. The vehicle 10 passes various speed limit signs 16_{1,2,3,4,5} (collectively 16).while driving along the road 12. In one embodiment, the signs 16_{1,3,4,5} display posted speed limits along the road 12, and the sign 16₂ displays a posted speed limit along the exit ramp 14. In the illustrated embodiment, the posted speed limits of the signs 16_{1,3,4} are 60 miles per hour (mph); the posted speed limit of the sign 16₂ is 30 mph; and the posted speed limit of the sign 16₅ is 70 mph.

As the vehicle 10 passes each of the signs 16, an image capturing device 20 (e.g., a camera) on the vehicle 10 captures respective images of the signs 16. The image capturing device 20 is capable of transmitting electronic signals representing images captured of the respective speed limit signs 16 along the road 12. Electronic signals representing the respective images are transmitted from the image capturing device 20 to an electronic control unit (ECU) 22 (e.g., a controller) on the vehicle 10. The ECU 22 receives the electronic signals from the image capturing device 20 and identifies a posted speed limit on the respective sign 16. For example, the posted speed limit identified from the electronic signals associated with the sign 16₁ is 60 mph, the posted speed limit identified from the electronic signals associated with the sign 16₂ is 30 mph, the posted speed limit identified from the electronic signals associated with the sign 16₃ is 60 mph, the posted speed limit identified from the electronic signals associated with the sign 16₄ is 60 mph and the posted speed limit identified from the electronic signals associated with the sign 16₅ is 70 mph.

If the ECU 22 identifies an over-speed condition, the ECU transmits an over-speed warning signal to activate a warning device 24. It is contemplated that the warning device 24 is positioned on the vehicle 10 such that the operator of the vehicle 24 is notified of the over-speed condition. For example, in one embodiment, it is contemplated that the warning device 24 is a display on a dashboard of the vehicle 10 (e.g., a light that is illuminated during the over-speed condition, a display showing the current speed and current speed limit, and/or a display conveying a message warning the operator of the vehicle of the over-speed condition, etc). In another embodiment, it is contemplated that the warning device 24 is a sound generating device (e.g., a buzzer) that is activated to generate a noise during the over-speed condition. It is also contemplated that the warning device 24 is any combination of the display and sound generating device.

A system for identifying an over-speed condition includes the image capturing device 20 and the ECU 22. In one embodiment, the ECU 22 identifies the over-speed condition if a speed of the vehicle 10 is greater than an actual speed limit by a predetermined percentage.

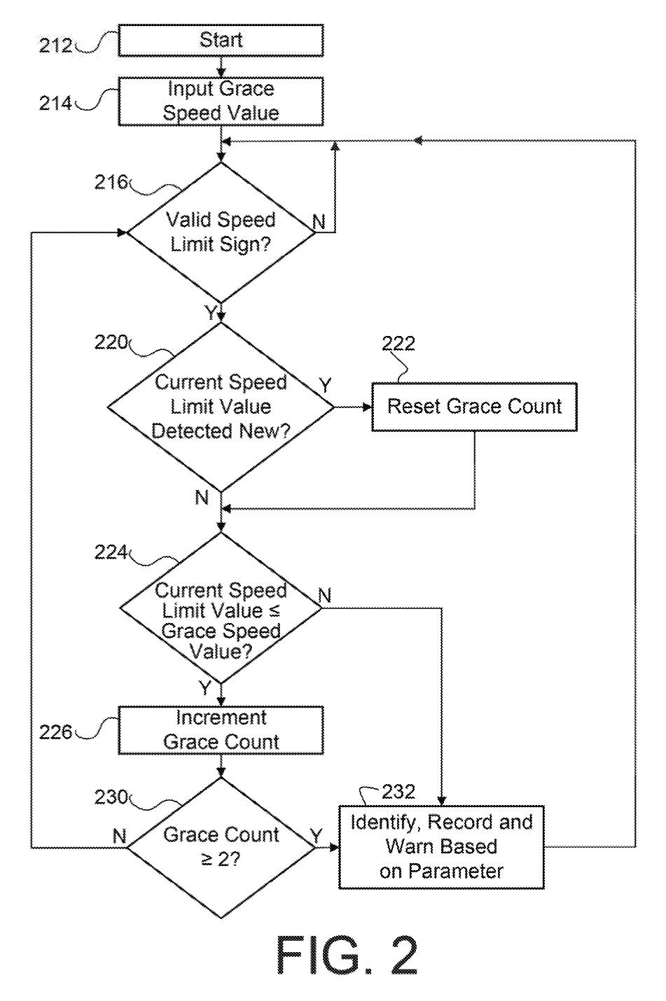

With reference to FIG. 2, an exemplary methodology of the system shown in FIG. 1 for identifying an over-speed condition is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1 and 2, the method starts in a step 212. In a step 214, a grace speed limit value is input. For example, the ECU 22 is programmed with the grace speed limit value, in the step 214, by an owner of the vehicle 10 (e.g., a fleet owner of a heavy vehicle). In one embodiment, it is contemplated that the grace speed limit value is 60 mph.

After receiving the electronic signals from the image capturing device 20, the ECU 22 determines if the signals represent a valid speed limit sign in a step 216. If it is determined the signals do not represent a valid speed limit sign (e.g., if the signals represent a route sign such as an interstate identification sign, a “Stop” sign, etc), control returns to the step 216. Otherwise, if it is determined the signals do represent a valid speed limit sign, the speed limit value on the sign is set to a current speed limit sign value and control then passes to a step 220.

In the step 220, a determination is made whether the current speed limit sign value is new. During the initial pass through the process, no previous speed limit values would have been detected. Therefore, during the initial pass, any current speed limit sign value detected is considered a new speed limit sign value. During subsequent passes through the process (i.e., after the initial pass), a new speed limit sign value is identified if the current speed limit sign value does not match the most recently detected speed limit sign value. For example, as the vehicle 10 travels along the road 12, the speed limit sign values detected are 60 mph, 30 mph, 60 mph, 60 mph and 70 mph from the respective signs 16₁, 16₂, 16₃, 16₄, 16₅. In this case, each of the speed limit sign values 60 mph, 30 mph, 60 mph and 70 mph from the signs 16₁, 16₂, 16₃, 16₅ are identified as new speed limit sign values, while the 60 mph from the sign 16₄ is not. If the current speed limit sign value is determined to be new in the step 220, control passes to a step 222, to reset a grace counter, and then control passes to a step 224. In one embodiment, the grace counter is reset to zero (0) in the step 222. Otherwise, control passes directly from the step 220 to the step 224.

In the step 224, a determination is made whether the current speed limit sign value is less than or equal to the grace speed limit value. If it is determined in the step 224 that the current speed limit sign value is less than or equal to the grace speed limit value, control passes to a step 226. The grace counter is incremented by, for example, one (1) in the step 226. Then, in a step 230, a determination is made whether the grace count is at least two (2). If it is determined in the step 230 that the grace count is not at least two (2), control returns to the step 216. Otherwise, if it is determined in the step 230 that the grace count is at least two (2), control passes to a step 232.

If it is determined in the step 224 that the current speed limit sign value is not less than or equal to the grace speed limit value, control passes directly from the step 224 to the step 232.

In the step 232, an over-speed condition is identified and recorded and the warning device 24 is activated based on a parameter (e.g., a current actual speed of the vehicle 10) and the current speed limit sign value. Control then returns to the step 216.

As discussed above, the vehicle 10 is travelling along the road 12 in the example illustrated in FIG. 1. As the vehicle 10 approaches the sign 16₁, the image capturing device 20 obtains an image of the sign 16₁, which includes the speed limit sign value identified on the sign 16₁ (e.g., a posted speed limit), and transmits signals to the ECU 22 representing that image. The ECU 22 receives the signal representing the image of the sign 16₁ and the speed limit sign value identified on the sign 16₁ and determines the sign 16₁ itself is a valid speed limit sign (e.g., not a stop sign) and identifies the speed limit sign value (i.e., 60 mph) as the current speed limit sign value (step 216).

Since this is the initial pass through the process, no previous speed limit sign values have been detected, and a previous speed limit sign value from a previous sign (e.g., first sign) is assumed to be zero (0). Therefore, the current speed limit sign value is determined as new in the step 220 and, therefore, control passes to the step 222 to reset the grace count to zero (0). Next, in the step 224, the current speed limit sign value (e.g., 60 mph) (e.g., second speed limit sign value from a second sign (i.e., the sign 16₁) is determined to be less than or equal to the grace speed limit value (e.g., 60 mph). Therefore, control passes to the step 226 to increment the grace count by one (1) so that the grace count is now one (1). Since the grace count is one (1) (i.e., not greater than or equal to two (2)) in the step 230, control returns to the step 216.

As the vehicle 10 continues traveling along the road 12 and approaches the sign 16₂, the image capturing device 20 obtains an image of the sign 16₂, which includes the speed limit sign value identified on the sign 16₂, and transmits signals to the ECU 22 representing that image. The ECU 22 receives the signal representing the image of the sign 16₂ and the speed limit sign value identified on the sign 16₂ and determines the sign 16₂ itself is a valid speed limit sign (e.g., not a stop sign) and identifies the speed limit sign value (i.e., 30 mph) as the current speed limit sign value (step 216).

Since the previous speed limit sign value associated with the previous sign 16₁ (e.g., first sign) was 60 mph and the current speed limit sign value associated with the current sign 16₂ (e.g., the second sign) is 30 mph, the current speed limit sign value (i.e., 30 mph) is determined as new in the step 220 and, therefore, control passes to the step 222 to reset the grace count to zero (0). Next, in the step 224, the current speed limit sign value (e.g., 30 mph) is determined to be less than or equal to the grace speed limit value (e.g., 60 mph). Therefore, control passes to the step 226 to increment the grace count by one (1) so that the grace count is now one (1). Since the grace count is one (1) (i.e., not greater than or equal to two (2)) in the step 230, control returns to the step 216.

As the vehicle 10 continues traveling along the road 12 and approaches the sign 16₃, the image capturing device 20 obtains an image of the sign 16₃, which includes the speed limit sign value identified on the sign 16₃, and transmits signals to the ECU 22 representing that image. The ECU 22 receives the signal representing the image of the sign 16₃ and the speed limit sign value identified on the sign 16₃ and determines the sign 16₃ itself is a valid speed limit sign (e.g., not a stop sign) and identifies the speed limit sign value (i.e., 60 mph) as the current speed limit sign value (step 216).

Since the previous speed limit sign value associated with the previous sign 16₂ (e.g., which is now referred to as the first sign) was 30 mph and the current speed limit sign value associated with the current sign 16₃ (e.g., which is now referred to as the second sign) is 60 mph, the current speed limit sign value (i.e., 60 mph) is determined as new in the step 220 and, therefore, control passes to the step 222 to reset the grace count to zero (0). Next, in the step 224, the current speed limit sign value (e.g., 60 mph) is determined to be less than or equal to the grace speed limit value (e.g., 60 mph). Therefore, control passes to the step 226 to increment the grace count by one (1) so that the grace count is now one (1). Since the grace count is one (1) (i.e., not greater than or equal to two (2)) in the step 230, control returns to the step 216.

As the vehicle 10 continues traveling along the road 12 and approaches the sign 16₄, the image capturing device 20 obtains an image of the sign 16₄, which includes the speed limit sign value identified on the sign 16₄, and transmits signals to the ECU 22 representing that image. The ECU 22 receives the signal representing the image of the sign 16₄ and the speed limit sign value identified on the sign 16₄ and determines the sign 16₄ itself is a valid speed limit sign (e.g., not a stop sign) and identifies the speed limit sign value (i.e., 60 mph) as the current speed limit sign value (step 216).

Since the previous speed limit sign value associated with the previous sign 16₃ (e.g., which is now referred to as the first sign) was 60 mph and the current speed limit sign value associated with the current sign 16₄ (e.g., which is now referred to as the second sign) is 60 mph, the current speed limit sign value (i.e., 60 mph) is determined to not be new in the step 220 and, therefore, control passes to the step 224. In the step 224, the current speed limit sign value (e.g., 60 mph) is determined to be less than or equal to the grace speed limit value (e.g., 60 mph). Therefore, control passes to the step 226 to increment the grace count by one (1) so that the grace count is now two (2). Since the grace count is two (2) in the step 230, control passes to the step 232.

In the step 232, the over-speed condition is identified and recorded and the warning device 24 is activated based on the parameter (e.g., a current actual speed of the vehicle 10) and the current speed limit sign value. (i.e., 60 mph). In the present example, if the current speed of the vehicle 10 is greater than the speed limit sign value (e.g., 60 mph) by a predetermined percentage (e.g., 10%), the over-speed condition is identified and recorded and the warning device 24 is activated. Therefore, the over-speed condition is identified and recorded (e.g., logged) and the warning device 24 is activated if the current speed of the vehicle 10 is greater than 66 mph.

As the vehicle 10 continues traveling along the road 12 and approaches the sign 16₅, the image capturing device 20 obtains an image of the sign 16₅, which includes the speed limit sign value identified on the sign 16₅, and transmits signals to the ECU 22 representing that image. The ECU 22 receives the signal representing the image of the sign 16₅ and the speed limit sign value identified on the sign 16₅ and determines the sign 16₅ itself is a valid speed limit sign (e.g., not a stop sign) and identifies the speed limit sign value (i.e., 70 mph) as the current speed limit sign value (step 216).

Since the previous speed limit sign value associated with the previous sign 16₄ (e.g., which is now referred to as the first sign) was 60 mph and the current speed limit sign value associated with the current sign 16₅ (e.g., which is now referred to as the second sign) is 70 mph, the current speed limit sign value (i.e., 70 mph) is determined as new in the step 220 and, therefore, control passes to the step 222 to reset the grace count to zero (0). Next, in the step 224, the current speed limit sign value (e.g., 70 mph) is determined to be greater than the grace speed limit value (e.g., 60 mph). Therefore, control passes to the step 232.

In the step 232, the over-speed condition is identified and recorded and the warning device 24 is activated based on the parameter (e.g., a current actual speed of the vehicle 10) and the current speed limit sign value. (i.e., 70 mph). In the present example, if the current speed of the vehicle 10 is greater than the speed limit sign value (e.g., 60 mph) by the predetermined percentage (e.g., 10%), the over-speed condition is identified and recorded and the warning device 24 is activated. Therefore, the over-speed condition is identified and recorded (e.g., logged) and the warning device 24 is activated if the current speed of the vehicle 10 is greater than 77 mph.

In the example of the process described above with reference to FIG. 1, it is noted that the step 232 is only performed when a speed limit sign value less than or equal to the grace speed limit value is identified by the ECU 22 as being on two (2) consecutive signs (e.g., the signs 16_{3,4}) passed by the vehicle 10 or when a single speed limit sign value greater than the grace speed limit value is identified by the ECU 22 (e.g., the sign 16₅). Therefore, an over-speed condition is not identified or logged and the warning device 24 is not activated based on the speed limit sign values in the signs 16_{1,2,3}. The over-speed condition is identified and logged and the warning device 24 is only activated based on the speed limit sign values in the signs 16_{4,5}.

Therefore, the ECU 22 acts as means for reducing the number of times an over-speed condition is identified and logged and the warning device 24 is activated based on the speed limit sign values.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A controller for identifying an over-speed condition of a vehicle, the controller adapted to:
identify a current posted speed limit;
determine whether to identify an over-speed condition of the vehicle based on the current posted speed limit, a previous posted speed limit and a current speed of the vehicle; and
if it is determined to identify the over-speed condition, transmit an over-speed warning signal to activate a warning device.

2. The controller for identifying an over-speed condition as set forth in claim 1, adapted to:
if it is determined to identify the over-speed condition, transmit an over-speed report signal to log the over-speed condition in a memory.

3. The controller for identifying an over-speed condition as set forth in claim 1, adapted to:
further determine to identify the over-speed condition of the vehicle if the current posted speed limit is greater than the predetermined grace speed value.

4. The controller for identifying an over-speed condition as set forth in claim 1, adapted to:
if the current posted speed limit and the previous posted speed limit are not equal, reset a grace count.

5. The controller for identifying an over-speed condition as set forth in claim 1, adapted to, if the current posted speed limit is not greater than the predetermined grace speed value:
increment the grace count; and
further determine to identify the over-speed condition based on the grace count.

6. The controller for identifying an over-speed condition as set forth in claim 1, adapted to, if the current posted speed limit is not greater than the predetermined grace speed value:
further determine to identify the over-speed condition if the grace count is at least two.

7. The controller for identifying an over-speed condition as set forth in claim 1, adapted to, if the current posted speed limit is not greater than the predetermined grace speed value:
further determine to identify the over-speed condition if the current speed of the vehicle is greater than the current posted speed by a predetermined percentage.

8. A controller for identifying an over-speed condition of a vehicle, the controller adapted to:
identify a first posted speed limit from an image of a first sign;
identify a second posted speed limit from a second image of a second sign;
determine whether to identify an over-speed condition of the vehicle based on the first and second posted speed limits and a current speed of the vehicle; and
if it is determined to identify the over-speed condition, transmit an over-speed warning signal to activate a warning device.

9. The controller for identifying an over-speed condition as set forth in claim 8, adapted to:
if it is determined to identify the over-speed condition, transmit an over-speed report signal to log the over-speed condition in a memory.

10. The controller for identifying an over-speed condition as set forth in claim 9, adapted to:
transmit the over-speed report signal to wirelessly transmit a notification of the over-speed condition to an off-vehicle.

11. The controller for identifying an over-speed condition as set forth in claim 8, adapted to:
further determine whether to identify the over-speed condition of the vehicle based on the second posted speed limit relative to a predetermined grace speed value.

12. The controller for identifying an over-speed condition as set forth in claim 11, adapted to:
further determine to identify the over-speed condition of the vehicle if the second posted speed limit is greater than the predetermined grace speed value.

13. The controller for identifying an over-speed condition as set forth in claim 11, adapted to:
if the first and second posted speed limits are not equal, reset a grace count.

14. The controller for identifying an over-speed condition as set forth in claim 13, adapted to, if the second posted speed limit is not greater than the predetermined grace speed value:
increment the grace count; and
further determine to identify the over-speed condition based on the grace count.

15. The controller for identifying an over-speed condition as set forth in claim 14, adapted to, if the second posted speed limit is not greater than the predetermined grace speed value:
further determine to identify the over-speed condition if the grace count is at least two.

16. The controller for identifying an over-speed condition as set forth in claim 15, adapted to, if the second posted speed limit is not greater than the predetermined grace speed value:
further determine to identify the over-speed condition if the current speed of the vehicle is greater than the second posted speed by a predetermined percentage.

17. A method for identifying an over-speed condition of a vehicle, the method comprising:
identifying a first posted speed limit from an image on a first sign;
identifying a second posted speed limit from a second image on a second sign;
identifying an over-speed condition of the vehicle based on the first and second posted speed limits and a current speed of the vehicle; and
if it is determined to identify the over-speed condition, transmitting an over-speed warning signal to activate a warning device.

18. The method for identifying an over-speed condition of a vehicle as set forth in claim 17, further including:
if it is determined to identify the over-speed condition, transmitting an over-speed report signal to log the over-speed condition in a memory.

19. The method for identifying an over-speed condition of a vehicle as set forth in claim 17, further including:
identifying the over-speed condition of the vehicle based on the second posted speed limit relative to a predetermined grace speed value.

20. The method for identifying an over-speed condition of a vehicle as set forth in claim 19, further including:
identifying the over-speed condition of the vehicle if the second posted speed limit is greater than the predetermined grace speed value.

21. The method for identifying an over-speed condition of a vehicle as set forth in claim 19, further including:
if the first and second posted speed limits are not equal, resetting a grace count.

22. The method for identifying an over-speed condition of a vehicle as set forth in claim 21, further including if the second posted speed limit is not greater than the predetermined grace speed value:
incrementing the grace count; and
identifying the over-speed condition based on the grace count.

23. The method for identifying an over-speed condition of a vehicle as set forth in claim 22, further including if the second posted speed limit is not greater than the predetermined grace speed value:
identifying the over-speed condition if the grace count is at least two.

24. The method for identifying an over-speed condition of a vehicle as set forth in claim 23, further including if the second posted speed limit is not greater than the predetermined grace speed value:
identifying the over-speed condition if the current speed of the vehicle is greater than the second posted speed by a predetermined percentage.

25. A system for identifying an over-speed condition of a vehicle, the system including:
an image capturing device capable of transmitting electronic signals representing images captured of respective speed limit signs along a road on which the vehicle is traveling;
a controller receiving the electronic signals from the image capturing device, the controller adapted to:
identify a first posted speed limit from an image of a first sign;
identify a second posted speed limit from a second image of a second sign;
determine whether to identify an over-speed condition of the vehicle based on the first and second posted speed limits and a current speed of the vehicle; and
if it is determined to identify the over-speed condition, transmit an over-speed warning signal to activate a warning device.

26. The system as set forth in claim 25, the controller further adapted to:
if it is determined to identify the over-speed condition, transmit an over-speed report signal to log the over-speed condition in a memory.

27. The system as set forth in claim 25, the controller further adapted to:
determine whether to identify the over-speed condition of the vehicle based on the second posted speed limit relative to a predetermined grace speed value.

28. The system as set forth in claim 27, the controller further adapted to:
determine to identify the over-speed condition of the vehicle if the second posted speed limit is greater than the predetermined grace speed value.

29. The system as set forth in claim 28, the controller further adapted to:
if the first and second posted speed limits are not equal, reset a grace count; and

30. The system as set forth in claim 29, if the second posted speed limit is not greater than the predetermined grace speed value, the controller further adapted to:
increment the grace count; and
further determine to identify the over-speed condition based on the grace count.

31. The system as set forth in claim 30, if the second posted speed limit is not greater than the predetermined grace speed value, the controller further adapted to:
determine to identify the over-speed condition if the grace count is at least two; and
determine to identify the over-speed condition if the current speed of the vehicle is greater than the second posted speed by a predetermined percentage.
